(19) United States
(12) Patent Application Publication
(10) Pub. No.: US 2004/0151978 A1
(43) Pub. Date: Aug. 5, 2004

(54) Method and apparatus for direct-write of functional materials with a controlled orientation

(76) Inventor: Wen C. Huang, Fargo, ND (US)

Correspondence Address: Wen C. Huang, 2902, 28TH AVE, S.W., FARGO, ND, 58103, US

(21) Appl. No.: 10/353,667

(22) Filed: Jan. 30, 2003

(51) Int. Cl. B05D 5/00; H01F 1/00

(52) U.S. Cl. 429/83; 427/256; 427/547; 118/665

(57) ABSTRACT

A direct-write method and apparatus for depositing a functional material with a preferred orientation onto a target surface. The method comprises the following steps: (1) forming a precursor fluid to the functional material, with the fluid containing a liquid component; (2) operating a dispensing device to discharge and deposit the precursor fluid onto the target surface in a substantially point-by-point manner and at least partially removing the liquid component from the deposited fluid to form a thin layer of the functional material which is substantially solidified and is of a predetermined pattern; and (3) during the liquid-removing step, subjecting the deposited fluid to a highly localized electric or magnetic field for poling until a preferred orientation is attained in the deposited functional material. The invention also provides a freeform fabrication method for building a multi-layer device, such as a micro-electro-mechanical system (MEMS), which contains sensor and actuator elements that exhibits piezoelectric, pyroelectric, ferromagnetic, electro-optic and/or other functional properties.

### FIELD OF INVENTION

This invention relates to a method and related apparatus for directly depositing a functional materials (e.g., a polarized material) with controlled or preferred orientation onto a substrate under the influence of a strong, localized electric or magnetic field. This invention also provides a freeform fabrication method and apparatus for making a multi-layered device that contains a functional or polarized material which is essentially stable up to its crystal melting point (if the polarized material is crystalline) or its softening point (if the material is non-crystalline). The functional material is substantially free of mechanically-induced orientation and has mechanical and electromechanical properties isotropic in a plane perpendicular to the poling direction of the imposing electric or magnetic field. The method is particularly useful for making a micro-electro-mechanical system (MEMS) featuring a polymeric material element with piezoelectric, pyroelectric, ferro-electric, ferromagnetic, ferri-magnetic, and/or non-linear optic properties.

### BACKGROUND

Recent advancements in the microelectronics industry have allowed integrated circuit (IC) chip manufacturer to achieve a very high packing density within a single IC chip. However, the electronics packaging industry has not seen the same degree of size reduction as in the IC industry. One reason for this difference lies in the need to utilize discrete active and passive devices on circuit boards as well as electrical interconnections to achieve fully functioning IC devices. Due to the requirement of placing each of the discrete devices onto the circuit board, various physical constraints dictate the size that the circuit board must maintain.

In order to miniaturize and integrate traditional microelectronic elements and functionally responsive devices (e.g., photonic and piezoelectric devices) together, a new sector of microelectronics industry, known as micro-electro-mechanical systems (MEMS), has started to emerge. MEMS are finding ever broadening applications, including complex sensor and actuator arrays that go into devices such as air bag activators, piezo-electric inkjet print-heads, and other miniature smart material devices. Many of the processes used to fabricate MEMS devices still depend on expensive and complicated semiconductor equipment and facilities, nevertheless. These processes are largely limited to silicon-based materials. Furthermore, some of the processing temperatures for MEMS fabrication are not compatible with electronic devices. Due to the ease of processing (including lower processing temperatures), lower cost and good mechanical integrity, selected polymers and organic materials have been considered to be ideal materials for MEMS and electronics applications.

In order to develop polymer-based MEMS, one must develop methods for depositing layers of materials comprising functionally active polymers (e.g., piezoelectric, pyroelectric, photonic, mechano-chemical, thermoelectric, etc.) and passive polymers (conducting, semi-conducting, insulating, dielectric, etc.) onto each other. Piezoelectric and pyroelectric materials are particularly useful elements in the MEMS devices for sensor and actuator applications. Hence, it is highly desirable to develop a direct-write method for directly depositing a piezoelectric or pyroelectric polymer onto a solid substrate.

Certain materials are capable of being polarized when subjected to mechanical or electrical stresses. For instance, poly (vinylidene fluoride) (PVDF) can be polarized by stretching a sheet of PVDF at a temperature of approximately 70° C. to at least three times its length, and subjecting the stretched sheet to a DC field of typically 1 MV/m or higher. PVDF has been a preferred polymeric material for polarization, since it has been found to have a high capability of polarization response, thereby providing high piezoelectric or pyroelectric properties or highly desired optical properties. Subjecting such a stretched film to a DC field applied in a direction perpendicular to the plane of the stretched film causes an orientation of the molecular dipoles of the materials. In the case of PVDF, the fluoro groups have a negative charge and the hydrogen atoms attached to the other carbon of the vinylidene fluoride unit of the polymer have a positive charge. Vinylidene fluoride units in a PVDF film are known to exist in at least two different crystalline forms: (1) a planar zigzag polar form or trans form (beta form or Form 1) and nonpolar and nonplanar T-G-T-G′ form (alpha form or Form 2) where T denotes trans configuration and G and G′ denote the two types of gauche forms. The desired increase in Form 1 has been realized by subjecting PVDF films to stretching and subsequently subjecting the stretched films to high DC fields over extended periods of time at high temperatures. Such a treatment with a DC field is referred to as poling. The polarized material is cooled after poling for the purpose of retaining the polarization. The existence of a high content of Form 1 is essential to achieving the highest amount of desired polarization properties required of good piezoelectric and pyroelectric responses.

Polarized PVDF materials are commonly used in making transducers, which utilize the piezoelectric or pyroelectric or other polarization properties of such polarized materials. It is well-known that various other polymers, such as polyvinylchloride (PVC), polyvinylfluoride (PVF), vinylidene fluoride copolymers, and many other polymers have the capability of being polarized as do a large number of ceramic materials such as lead zirconate titanate (PZT).

Mechanical stretching in the film direction causes an unequal (or anisotropic) strength in the stretching or axial direction (X-X₁) as compared to the transverse direction (Y-Y₁). This is an undesirable attribute of the piezoelectric polymers. Instead, it is desired to provide polymers which are substantially free of such mechanically induced orientation and which have a polarization that is stable up to the crystal melting point (if the polarized material is crystalline) or material softening point (if non-crystalline). Furthermore, the need to mechanically stretch a polymer film is not compatible with traditional microelectronics fabrication processes. In order to fabricate a MEMS device that contains a piezoelectric polymer element, it is essential to develop a direct-write method for directly depositing polarized or polarizable polymers to a solid substrate without post-deposition stretching. Scheinbeim, et al. (U.S. Pat. No. 4,830,795, May 16, 1989 and U.S. Pat. No. 4,863,648, Sep. 5, 1989) proposed a solvent polarization method to produce a thick film of a simple geometry; however, no method has been proposed that allows direct deposition of a thin film of a polarizable material in a predetermined pattern on a solid substrate. It is desired to integrate such a direct-write method with other microelectronic fabrication methods or solid freeform fabrication methods to fabricate a multi-layer device on a point-by-point and layer-by-layer basis. Further, the patents of Scheinbeim, et al. do not provide an effective method or apparatus for producing a strong, highly localized electric field for poling of micron- or nanometer-scaled piezo-electric elements or other types of functional materials. Their methods are, therefore, not suitable for the direct-write of MEMS device elements.

In addition to piezo-electric or pyroelectric materials, many polymeric and other molecular electronic devices depend upon the orientation of the elements for their properties. For instance, the orientation of a non-symmetric molecule is crucial to the ferromagnetic, non-linear optic, and surface conductive properties of functional organic materials, including polymers. No known prior-art direct-write method is capable of directly depositing micron- or nanometer-scaled molecular structures with controlled in-plane or out-of-plane orientations. In the present context, micron-scale means 10 μm or smaller (preferably smaller than 1 μm) and nanometer-scale means 200 nm or smaller, preferably smaller than 100 nm.

It is an object of the present invention to provide a method and apparatus for direct-write of miniaturized functional elements with a controlled orientation.

It is another object of the present invention to provide a method and apparatus for direct-write of functional elements under the influence of a strong, highly localized electric or magnetic field.

It is yet another object of the present invention to provide a method and apparatus for direct-write of functional elements under the influence of a strong, highly localized electric or magnetic field generated by using a split-tip proximal probe.

A specific object of the present invention is to provide a method and apparatus for direct-write of piezo-electric elements for MEMS applications.

Another specific object of the present invention is to provide a method and apparatus for direct-write of micron- or nanometer-scaled molecular structures with controlled orientations.

### SUMMARY OF INVENTION

A direct-write method has been developed by which functional materials with preferred orientations (e.g., highly polarized materials) in the form of a patterned thin film can be directly deposited onto a solid substrate. The materials deposited are substantially free of mechanically induced orientation. For polarized materials, their orientation or polarization is essentially stable up to about the crystal melting point of the polarized material in the case of a crystalline material or up to about the softening point (glass transition temperature) of the polarized material in the case of non-crystalline polarized material.

The method comprises the following steps: (1) forming a precursor fluid to the functional material, with the fluid containing a liquid component; (2) operating a dispensing device to discharge and deposit the precursor fluid onto a target surface in a substantially point-by-point manner and at least partially removing the liquid component from the deposited fluid to form a thin layer of the functional material, which is substantially solidified and is of a predetermined pattern; and (3) during the liquid-removing step, subjecting the deposited fluid to a highly localized electric or magnetic field for poling until a preferred orientation is attained in the deposited functional material.

In the case of a polarizable material such as PVDF, the method includes dissolving a material to be polarized in a solvent or solvents for that material to form a solution. The solution is then dispensed in the form of fine discrete droplets or a continuous strand in a fluent state and deposited onto a target surface in an essentially point-by-point and layer-by-layer fashion. The target may be a semiconducting substrate or a conducting electrode supported on the surface of a substrate. The solvent is selected which is adapted to the polarization of the material and which can be removed to the extent desired during the course of the polarization. A strong, highly localized electric field is applied to polarize the deposited material while the solvent is being removed. The temperature employed will be one at which polarization effectively occurs, normally at an elevated temperature below which no substantial dielectric breakdown occurs. The DC field employed in the polarization will be properly to provide the desired polarization.

In one preferred embodiment, the predetermined pattern of the deposited functional material comprises micron- and/or nanometer-scaled regions of the functional material. The present method allows variation of the orientation on a small scale when the highly localized electric or magnetic field is substantially focused in a region smaller than 10 μm in size. In one further preferred embodiment, the highly localized electric or magnetic field is generated by using a split-tip proximal probe. In another preferred embodiment, the field is generated by a multiplicity of split-tip probes (two or more probes, preferably in a regular array).

The target surface may be preheated or precooled to a desired temperature and may be exposed to a controlled atmosphere. The controlled atmosphere may be selected from a group consisting of a vacuum, an inert gas, a reactive gas, and a combination of an inert gas and a reactive gas. The liquid-removing step may involve operating a device selected from the group consisting of a ventilation fan, a vacuum pump, a hot air blower, a heater, or a combination thereof.

The functional material may be selected from the group consisting of a piezo-electric material, a pyroelectric material, a ferro-electric material, a non-linear optic material, a conducting polymer, a ferromagnetic material, a ferri-magnetic material, an anti-ferromagnetic material, a liquid crystal material, or a combination thereof.

In one preferred embodiment, the dispensing device comprises a device selected from the group consisting of an inkjet printhead, a liquid droplet generator, an extrusion device, a gear pump, an air pressure pump, a positive displacement pump, a screw-driven pump, a syringe pump, a fused deposition modeling nozzle, or a combination thereof Any device that provides a small-scale continuous stream of fluid or small droplets of fluid on demand may be used as a dispensing device in practicing the present invention.

Also provided by this invention is a freeform fabrication method by which a multi-layer device containing a functional material with a controlled or preferred orientation can be produced point by point and layer by layer. Individual layers may comprise a patterned thin film of a polarized material and/or other electronically active or passive materials such as a conductor, resistor, semi-conductor, capacitor, inductor, superconductor, diode, transistor, light-emitting element, light-sensing element, solar cell element, sensor, actuator, semiconductor logic element, electro-optic logic element, spin material, magnetic material, thermo-electric element, electromagnetic wave emission, transmission or reception element, electronically addressable ink, or a combination thereof. The polarizable material presently preferred is poly (vinylidene fluoride) or certain copolymers of vinylidene fluoride. A functionally responsive device such as a micro-electro-mechanical system (MEMS) can be fabricated point by point and layer by layer under the control of a computer in accordance with a computer-aided design (CAD) of this device.

The present invention also provides a direct-write apparatus for depositing a functional material with a preferred orientation from a precursor fluid containing a liquid component. The apparatus includes, in combination, the following components: (1) a target surface on which the functional material is supported while being deposited; (2) a dispensing device at a distance from the target surface (the dispensing device having an orifice through which the precursor fluid is dispensed and deposited onto the target surface in a substantially point-by-point manner); (3) a liquid-removing provision a distance from the orifice, or surrounding the orifice, to at least partially remove the liquid component from the deposited fluid; (4) a field source (e.g., one or a multiplicity of split-tip probes in a regular array) a distance from the orifice, but in the vicinity, for providing a highly localized electric or magnetic field for poling the deposited fluid while the liquid component is being removed; and (5) movement devices, preferably with an automatic machine control system, in control relation to the dispensing device for moving the dispensing device relative to the target surface. This apparatus makes it possible to deposit functional materials and, if so desired, other types of materials, point by point and layer by layer.

### BRIEF DESCRIPTION OF THE DRAWING

FIG. 1. A schematic representation of an apparatus used to deposit a patterned thin film of a functional material and to provide a localized electric field for the polarization of the material when the solvent is being removed by evaporation during poling.

FIG. 2(A) Schematic of a split-tip proximal probe as a source for generating a highly localized, strong electric field and (B) Schematic of a split-tip proximal probe as a source of localized magnetic field that serves to orient magnetic molecules or particles.

FIG. 3. A schematic representation of an apparatus used to deposit a patterned thin film of a functional material and to provide a localized electric field for the polarization of the material. The localized electric field is inclined at an angle relative to the target surface.

### DETAILED DESCRIPTION OF THE INVENTION AND THE PREFERRED EMBODIMENTS

One preferred embodiment of the present invention is a direct-write method capable of directly depositing a functional material with a preferred orientation in the form of a patterned thin film onto a solid substrate. The method includes the steps of (1) forming a fluid that is a precursor to the functional material, with the fluid containing a liquid component; (2) operating a dispensing device to discharge and deposit the precursor fluid onto a target surface in a substantially point-by-point manner (much like in a solid freeform fabrication or layer manufacturing process) and at least partially removing the liquid component from the deposited fluid to form a thin layer of the functional material, which is substantially solidified into a predetermined pattern; and (3) during the liquid-removing step, subjecting the deposited fluid to a highly localized electric or magnetic field for poling until a preferred orientation is attained in the deposited functional material.

For the mere purpose of illustrating the essential steps of the invented method, a polarizable material such as poly(vinylidene fluoride) or PVDF is used herein as an example. In this case, the method begins by first dissolving the material to be polarized in the required amount of a suitable solvent or solvents to form a solution. In the case of PVDF, a solvent such as tricresylphosphate can be used. Approximately 5% by weight of PVDF can be dissolved in 95% of tricresylphosphate or another polarization solvent for making the solution for deposition. The mixture may be heated to about 180° C.-190° C. to accelerate the dissolution step. A capacitor grade PVDF available from Kureha Kagoku Kogko Kabishiki Kaisha was found to be suitable.

Once a solution is prepared, one may reduce the solvent content in the solution prior to being dispensed from a dispensing device onto a target surface for polarization. For example, in the case of PVDF/tricresylphosphate solution, the solvent content can be reduced from 95% to 50% or below such as to 25% or lower provided that the PVDF material remains in solution and that the viscosity of the resulting solution is not too excessive to allow for proper dispensing.

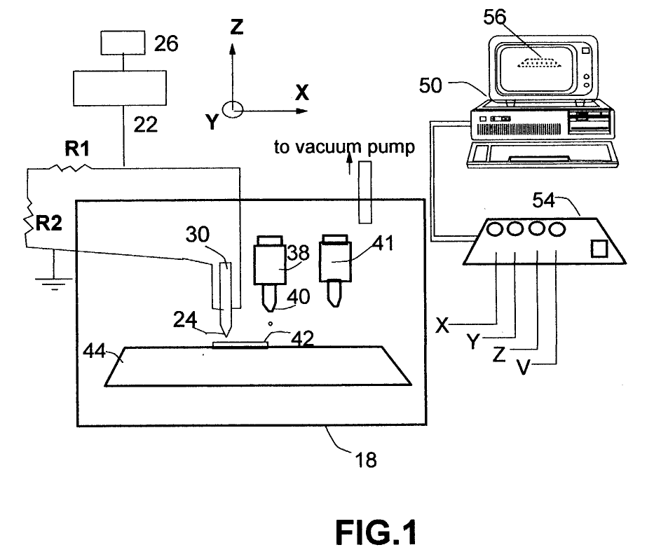

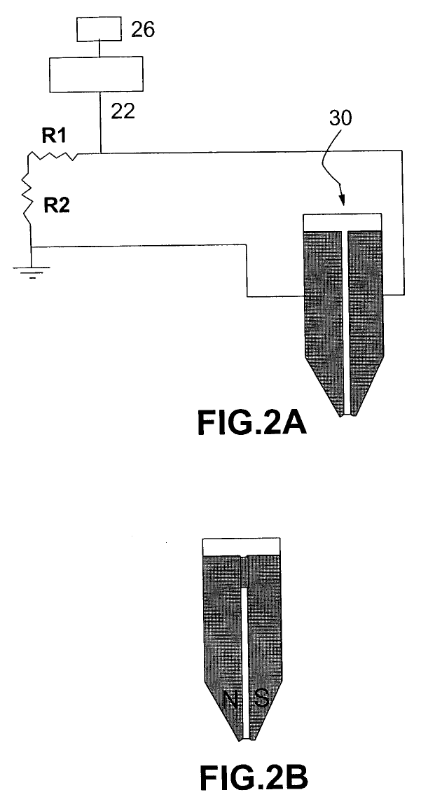

As shown in FIG. 1, the solution of PVDF with the reduced solvent content can be introduced into a dispensing device 38 which has at least a nozzle 40 through which the solution may be discharged, continuously or intermittently on demand, into a form of discrete fine droplets or a thin continuous strand. The dispensed solution is deposited onto a target surface 44 essentially point by point to form a thin film 42 of a predetermined pattern. Both the dispensing device 38 and the target surface 44 are preferably placed into a suitable vacuum oven 18. The PVDF solution deposited, preferably in small micron- or nanometer-scale regions, is placed under the influence of a localized electric field produced between two closely positioned electrodes (e.g., on two sides of an optical fiber based split-tip probe 30 in FIG. 1, with further details being shown in FIG. 2A) for poling. The electrodes are equipped with an appropriate DC source 22 controlled by a DC voltage ramping unit 26.

Preferably, the localized electric field is generated by a split-tip probe (FIG. 2A). In one preferred embodiment, the split-tip probe consists of two electrically isolated and independently contacted metal electrodes deposited on opposite sides of a tapered optical fiber, similar to those used for near-field scanning optical microscopy (NSOM). The probe used in the present invention is fabricated using similar processes as the NSOM tips. Flat-ended and sharptipped optical fibers may be produced by using pulling and chemical etching methods, respectively. The fabrication of split-tip probes is a known art in the field of NSOM (e.g., see Mufei Xiao, et al. “Fabrication of probe tips for reflection SNOM: Chemical etching and heating-pulling methods,” Journal of Vacuum Sci. Tech. B15 (1997) 1516; P. Hoffmann, et al. “Comparison of mechanically drawn and protection layer chemically etched optical fiber tips,” Ultramicroscopy, 61 (1995) 165.; and H. D. Hallen, “Deposition of molecular nanostructures with controlled in-plane orientation,” in 2003 NSF Design, Service and Manufacturing Grantees and Research Conference Proceeding, Ed. By R. G. Reddy, pp.2617-24.). Once the fiber is shaped, metal is coated on one side of the fiber to form one electrode. Then, the fiber is rotated 180° so that the opposite side can be coated with the same or different metal to form another electrode. This forms a split metal structure with the two metal sides electrically isolated. Copper, aluminum, gold, or any metallic element or alloy can be deposited as the electrodes. The electric field is provided through the high voltage DC source after the solution is deposited and when a portion of the solvent is being removed. Temperature of the deposited material is adjusted as desired. It is advantageous to use a temperature that provides a high rate of solvent removal and a high rate of polarization without substantial dielectric breakdown of the material being polarized.

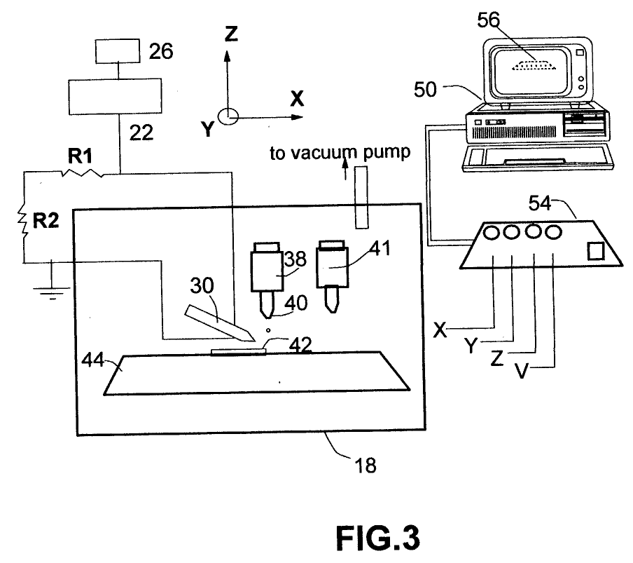

The optical fiber end is sized from several hundred nanometers (nm) down to approximately 10 nm. Assume that the two oppositely positioned electrodes can be simulated as a parallel-plate capacitor, the electric field strength may be estimated as follows. With 1 volt applied across the electrodes that are 10 nm apart, a field strength of (1V/(10×10⁻⁹ m)=10⁸ V/m) is obtained. This implies that an extremely high-strength, and localized electric field is readily available by using a split-tip probe. This capability to generate strong, localized electric field for orienting polar molecules has not been, up to this point of time, reported for use in direct-write technology. The split-tip probe may also be inclined at an angle relative to the target surface (FIG. 3). This angle may be varied to change the molecular orientation direction.

A split-tip type probe may also be made to produce a highly localized magnetic field if a strong magnet material is deposited onto opposite sides of the sharp tip of a chemically etched optical fiber (FIG. 2B). In this case, one side has a N pole while the opposite side has a S pole. Such a highly localized magnetic field provides a great improvement to the resolution (producing oriented-dipole magnetic domains with reduced sizes), making it possible to deposit functional elements (with preferred orientations) on ultra-small scales (micron or nanometer). A localized magnetic filed may also be produced by a micron-scale solenoid coil supplied with an electric current. Magnetic materials may be a polymeric or non-polymeric organic or inorganic ferromagnetic and ferrimagnetic material, which is dissolved in a solvent to form a solution or a gel, or simply dispersed as discrete particles in a liquid to form a “slurry” (a liquid-solid mixture). These particles are preferably micron- or nanometer-scaled. Once dispensed and deposited, the liquid or solvent is at least partially removed while the material fluid is subjected to the orientation treatment under the influence of the localized magnetic field.

It may be noted that a direct-write system can make use of a multiplicity (2 or more) of split-tip types of probes to produce localized electric and/or magnetic fields. These probe tips are preferably arranged in a regular-interval array for easier control.

A wide range of dispensing devices can be selected for use in practicing the present method. A dispensing device may contain an inkjet printhead, liquid droplet generator, extrusion device, gear pump, air pressure pump, positive displacement pump, screw-driven pump, syringe pump, fused deposition modeling nozzle, or a combination thereof These devices are well known in the art of liquid dispensing, rapid prototyping, and inkjet printing. There are many commercially available inkjet print heads that are capable of dispensing the material compositions in the presently invented method. Examples include those supplied by the Lee Company (Westbrook, Conn., USA), Tektronix (Beavorton, Oreg., USA), and Spectra, Inc. (Keene, N.H., USA). A multiplicity of dispensing devices (having a plurality of nozzles or nozzle orifices) may be used to deposit different material compositions sequentially or concurrently. FIG. 1 only shows two nozzles, 38 and 41, but any number of nozzles may be used. At least one of the nozzles or nozzle orifices is used to deposit the functional material precursor fluid while at least another nozzle or orifice may be used to deposit other materials in the same layer, or different layers if a multi-layer device is being made. These other materials may contain a composition selected from the group consisting of a conductor, resistor, semi-conductor, capacitor, inductor, superconductor, diode, transistor, light-emitting element, light-sensing element, solar cell element, sensor, actuator, semiconductor logic element, electro-optic logic element, spin material, magnetic material, thermo-electric element, electromagnetic wave emission, transmission or reception element, electronically addressable ink, or a combination thereof. In order to print a MEMS device, several of these materials will be deposited also point by point and layer by layer.

Generally speaking, printing of conductors and resistors is well known in the art of circuit board manufacture. For instance, Drummond, et al. (U.S. Pat. No. 5,132,248, Jul. 21, 1992) provide a direct-write method for depositing a metal or dielectric onto a substrate such as a semiconductor. The material is deposited by providing a colloidal suspension of the material and directly writing the suspension onto the substrate surface by inkjet printing techniques. The deposited material is then resolved into a desired pattern by using laser annealing. Castro, et al. (U.S. Pat. No. 5,378,508, Jan. 3, 1995) provide a laser direct write method for depositing metal on a dielectric substrate from a mixture of a salt and amine or amide compound. Auerbach (U.S. Pat. No. 4,526,807, Jul. 2, 1985) proposes a method for deposition on a substrate of elemental metals and metalloids in the form of conducting lines, spots and the like. The method involves (a) preparing a solution or dispersion of a reducible metal or metalloid compound in an oxidizable organic matrix such as a polyamic acid or polyimide, (b) coating the substrate with this solution or dispersion, and (c) contacting the coated substrate with a laser beam. Direct deposition of gold and palladium was studied by Sharma, et al. (U.S. Pat. No. 5,846,615, Dec. 8, 1998 and U.S. Pat. No. 5,894,038, Apr. 13, 1999). Chemical vapor deposition of copper, silver, and gold from a cyclopentadienyl/metal complex was achieved by Beach, et al. (U.S. Pat. No. 4,948,623, Aug. 14, 1990). Holdcraft, et al. (U.S. Pat. No. 5,561,030, Oct. 1, 1996) disclose a method for fabricating electronically conducting polymer patterns. Selective laser pyrolysis was utilized by Mantese, et al. (U.S. Pat. No. 4,916,115, Apr. 10, 1990) to fabricate thin-film patterned superconductors.

Inkjet printing was adapted by Jacobson (U.S. Pat. No. 6,120,588, Sep. 19, 2000) for depositing electronic inks, conductors, insulators, resistors, semi-conductive materials, magnetic materials, spin materials, piezoelectric materials, opto-electronic, thermoelectric or radio frequency materials. Some of these materials (e.g., magnetic materials, spin materials, piezo-electric materials, electro-strictive materials, and electronic inks), if so desired, may be dispensed to form the functional material with a preferred orientation. Other materials (e.g., insulators and conductors) may be deposited at other locations of a layer. Fluid jetting, electro-plating, and electrodeless plating techniques were used by Jacobsen, et al. (U.S. Pat. No. 6,200,508, Mar. 13, 2001) to deposit electromechanical devices. Printable electronic inks are used by Comiskey and Albert, et al. (e.g., U.S. Pat. No. 6,177,921, Jan. 23, 2001 and U.S. Pat. No. 6,252,564, Jun. 26, 2001) for making flexible displays. Miller, et al. (U.S. Pat. No. 6,251,488, Jun. 26, 2001) discloses a method that combines a powder spray process with in-flight laser treatment in order to produce direct write electronic components. Any of the above-cited methods can be used in combination with the presently invented method to fabricate a microelectronic or MENS device.

During the liquid-removing step, the liquid (solvent) content can be reduced during the polarization by passing a flow of a suitable gas (e.g., nitrogen) over the surface of the deposited film. Alternatively, a vacuum pump may be utilized to pump out the vaporized solvent continuously.

A proper intensity of the electric field used can be selected to provide efficient polarization. However, it is preferably kept below the range at which substantial dielectric breakdown of the material being polarized occurs. In the case of PVDF, an electrical field of 250 KV/cm (2.5×10⁷ V/m) was found to be satisfactory to pole a PVDF solution having a 25 percent solvent content. The electrical field could be increased to 500 KV/cm as the solvent content decreased and increased further to 750 KV/cm when the solvent content is further reduced to about 15 percent. The further increase of the electrical field beyond 750 KV/cm at 15 percent solvent can result in some dielectric breakdown, for example, in the range of about 800 to about 1000 KV/cm. The above conditions are similar to those used by Scheinbeim, et al. (U.S. Pat. No. 4,830,795, May 16, 1989 and U.S. Pat. No. 4,863,648, Sep. 5, 1989).

The temperature at which the polarization process is carried out depends upon the desired rate at which polarization occurs, the material used, the solvent used, the equipment available for polarization, the desired level of solvent wished to be retained in the final polarization material and other factors. A poling temperature of in the range of 60°- of 90° C. was found to give satisfactory results. The poling temperature should be maintained lower than the boiling point of the solvent under the conditions used.

A wide range of materials can be used in practicing this invention. A preferred polarizable material for the purpose of obtaining a preferred molecular orientation to achieve a desired level of piezo-electric or pyroelectric response, is poly(vinylidene fluoride). Copolymers of vinylidene fluoride are also useful materials. These include vinylidene fluoride copolymers with vinyl fluoride, trifluoroethylene, tetrafluoroethylene, vinyl chloride, methylmethacrylate, and others. The vinylidene fluoride content can vary in the range of from about 30% by weight to about 95% by weight. Other polymers which can be used are polyvinylchloride, polymethylacrylate, polymethylmethacrylate, vinylidene cyanide/vinyl acetate copolymers, vinylidene cyanide/vinyl benzoate copolymers, vinylidene cyanide/isobutylene copolymers, vinylidene cyanide/methyl methacrylate copolymers, polyvinylfluoride, polyacrylonitrile, polycarbonate, and nylons such as Nylon-7 and Nylon-11, natural polymers such as cellulose and proteins, synthetic polymers such as derivatives of cellulose, such as esters and ethers, poly (γ-methyl-L-glutamate), and the like. In addition, polarizable materials which are soluble ceramic materials and capable of forming polar crystals or glasses can be used together with an appropriate polarization solvent for a particular soluble ceramic material used.

Ferromagnetic materials that can be subjected to orientation treatments include, but not limited to, decamethylferrocene-TCNE charge transfer compound, zwitterionic copolymers and those having the general formula A:N—B (where A:N—is α-substituted cyclic amine and B is α-substituted cyclic radical), as disclosed by Leriche, et al. (U.S. Pat. No. 6,262,306, Jul. 17, 2001).

A variety of organic solvents can be used, depending upon the functional material used, cost and safety consideration, equipment used, and other factors. Tricresylphosphate has been found to be a suitable solvent for PVDF and many copolymers of vinylidene fluoride. Dibutyl phthalate can also be used as the solvent for these vinylidene polymers. For nylon-7 and nylon-11, 2-ethyl-1,3-hexanediol can be used.

In addition, other functionally responsive materials such as liquid crystals (including liquid crystal polymers) and self-assembled molecules (SAM) that depend upon molecular orientations to achieve their anisotropic properties may also be deposited using the presently invented method.

Process Details and Needed Hardware:

The present invention also provides a direct-write apparatus for depositing a functional material with a preferred orientation from a precursor fluid containing a liquid component. The apparatus includes, in combination, the following components:

(1) a target surface on which the functional material is supported while being deposited; (The target surface is preferably pre-set at a desired temperature and under a controlled atmosphere.)

(2) a dispensing device at a distance from the target surface; (The dispensing device preferably has an orifice through which the precursor fluid is dispensed and deposited onto the target surface in a substantially point-by-point manner.)

(3) a liquid-removing provision a distance from the orifice, or surrounding the orifice, to at least partially remove the liquid component from the deposited fluid; (A low-pressure environment facilitated by a vacuum pump promotes vaporization of the liquid component. The vacuum pump also serves to continuously pump out the vapor.)

(4) a field source, e.g. one or a multiplicity of split-tip probes in a regular array, a distance from the orifice, but in its vicinity, for providing a highly localized electric or magnetic field for poling the deposited fluid while the liquid component is being removed; and

(5) movement devices, preferably with an automatic machine control system, in control relation to the dispensing device for moving the dispensing device relative to the target surface. This apparatus makes it possible to deposit functional materials and, if so desired, other types of materials, point by point and layer by layer.

Referring to FIG. 1 or FIG. 3, the process involves intermittently or continuously dispensing a fluent precursor to the desired functional material (e.g., a PVDF-solvent solution) through an orifice 40 of a dispensing head 38 to deposit onto a target surface 44 of a support member. During this dispensing procedure, the target surface and the dispensing head are moved (preferably under the control of a computer 50 and a controller/indexer 54) with respect to each other along selected directions in a predetermined pattern on an X-Y plane defined by first (X-) and second (Y-) directions and along the Z-direction perpendicular to the X-Y plane. The three mutually orthogonal X-, Y- and Z-directions form a Cartesian coordinate system. These relative movements are effected so that the material composition can be deposited essentially point by point and layer by layer to build a single-layer or multiple-layer object according to a computer-aided design (CAD) drawing 56 of a 3-D object.

In one preferred embodiment, an optional heating provision (e.g., heating elements) is attached to, or contained in, the dispensing head to control the physical and chemical state of the material composition; e.g., to help maintain it in a fluent state. A temperature sensing means (e.g. a thermocouple) and a temperature controller can be employed to regulate the temperature of the dispensing head and the deposition chamber 18. The target surface may be preheated or pre-cooled to a desired temperature. The target surface may be maintained at a temperature sufficient for initiating and sustaining a chemical reaction of the deposited precursor fluid, with the reaction products comprising the desired functional material. Heating means are well known in the art.

As indicated earlier, the dispensing head may be advantageously designed to comprise a plurality of discharge orifices. Several commercial sources provide inkjet print-heads that contain from several hundred to more than 1,500 discharge orifices. In another embodiment of the presently invented method, the dispensing head may comprise a plurality of inkjet print heads, each comprising a single orifice or a plurality of discharge orifices. Such a multiple-printhead dispensing system is desirable because an operator may choose to use different material compositions to build different portions of an object or device. Different material compositions could include different electronically responsive materials or simply just inert packaging materials such as epoxy or polyimide resins.

Referring again to FIG. 1, the target surface 44 is located in close, working proximity to (at a predetermined initial distance from) the dispensing head 38. The target surface preferably has a flat region sufficiently large to accommodate the first few layers of deposited material composition. The target surface and the dispensing head are equipped with mechanical drive means for moving the target surface relative to the movable dispensing head in three dimensions along “X,” “Y,” and “Z” axes in a predetermined sequence and pattern, and for displacing the dispensing head a predetermined incremental distance relative to the target surface. This can be accomplished, for instance, by allowing the target surface and the dispensing head to be driven by three separate linear motion devices, which are powered by three stepper motors. Linear motion devices and X-Y-Z gantry tables are commercially available. Z-axis movements are effected to displace the nozzle relative to the support member and, hence, relative to each layer deposited prior to the start of the formation of each successive layer. This will make it possible to form multiple layers of predetermined thicknesses, which build up on each other sequentially as the precursor fluid solidifies after being discharged from the orifice. Instead of stepper motors, many other types of drive means can be used, including linear motors, servo motors, synchronous motors, D.C. motors, and fluid motors.

It may be noted that the precursor fluid can be simply a mixture of a functional material particles and a liquid or a solution of a functional material dissolved in a solvent. Upon deposition, the liquid or solvent component may be removed through vaporization. The precursor fluid can be a chemically reactive species that undergoes a chemical reaction or decomposition to transform the species into the desired functional material after being deposited. This chemical reaction may be activated or accelerated by a heated target surface. The orientation treatment can proceed simultaneously with either the vaporization or chemical reaction process.

Computer-Aided Design and Process Control:

A preferred embodiment of the present invention is an improved solid freeform fabrication method, which begins with the creation of a model (e.g., via computer-aided design, CAD), which is a data representation of a 3-D object (or a MEMS device, e.g.). This model is stored as a set of numerical representations of layers which, together, represent the whole object. A series of data packages, each data package corresponding to the physical dimensions, shape and material compositions of an individual layer, is stored in the memory of a computer in a logical sequence.

In one preferred approach, before the constituent layers of a 3-D object are formed, the geometry of this object is logically divided into a sequence of mutually adjacent theoretical layers, with each theoretical layer defined by a thickness and a set of closed, nonintersecting curves lying in a smooth two-dimensional (2-D) surface. These theoretical layers, which exist only as data packages in the memory of the computer, are referred to as “logical layers.” This set of curves forms the “contour” of a logical layer or “cross section”. In the simplest situation, each 2-D logical layer is a plane so that each layer is flat, and the thickness is the same throughout any particular layer. However, this is not necessarily so in every case, as a layer may have any desired curvature and the thickness of a layer may be a function of position within its II two-dimensional surface. The only constraint on the curvature and thickness function of the logical layers is that the sequence of layers must be logically adjacent. Therefore, in considering two layers that come one after the other in the sequence, the mutually abutting surfaces of the two layers must contact each other at every point, except at such points of one layer where the corresponding point of the other layer is void of material as specified in the object model.

The closed, nonintersecting curves that are part of the representation of each layer unambiguously divide a smooth two-dimensional surface into two distinct regions. In the present context, a “region” does not mean a single, connected area. Each region may consist of several island-like subregions that do not touch each other. One of these regions is the intersection of the surface with the desired 3-D object, and is called the “positive region” of the layer. The other region is the portion of the surface that does not intersect the desired object, and is called the “negative region.” The curves that demarcate the boundary between the positive and negative regions, and are called the “outline” of the layer. In the present context, various material compositions (including a functional material with a preferred orientation such as a polarized material) are allowed to be deposited in the “positive region” while, optionally, an electrically insulating material (e.g., epoxy or polyimide resin) may be deposited in certain parts or all of the “negative region” in each layer to serve as a support structure. Electrically conducting elements may be deposited between functional materials to serve as the “interconnects”.

In one alternative embodiment of the present invention, the method involves depositing a lower-melting material in all of the negative regions in each layer to serve as a support structure. This support structure may be removed at a later stage or at the conclusion of the object-building process. The presence of a support structure (occupying the negative region of a layer), along with the object-building material (the positive region), will completely cover a layer before proceeding to build a subsequent layer.

As a specific example, the geometry of a three-dimensional object may be converted into a proper format utilizing commercially available CAD software. A commonly used format in solid freeform fabrication is the stereo lithography file (.STL), which has become a de facto industry standard for rapid prototyping. Another useful data format is the virtual reality modeling language (VRML) that contains not only geometry but also material composition data. The object image data may be sectioned into multiple layers by a commercially available software program. Each layer has its own shapes, dimensions, and material composition distributions which define both the positive region and the negative region. These layers, each being composed of a plurality of segments or data points, when combined together, will reproduce the intended object.

When a multi-material object is desired, these segments or data points are preferably sorted in accordance with their material compositions. This can be accomplished by taking the following procedure: When the stereo lithography (.STL) format is utilized, the geometry is represented by a large number of triangular facets that are connected to simulate the exterior and interior surfaces of the object. The triangles may be so chosen that each triangle covers one and only one material composition. In a conventional .STL file, each triangular facet is represented by three vertex points each having three coordinate points, (x₁,y₁,z₁), (x₂,y₂,z₂) and (x₃,y₃,z₃), and a unit normal vector (i,j,k). Each facet is now further endowed with a material composition code to specify the desired material composition. This geometry representation of the object is then sliced into a desired number of layers expressed in terms of any desired layer interface format (such as Common Layer Interface or CLI format). During the slicing step, neighboring data points with the same material composition code on the same layer may be sorted together. These segment data in individual layers are then converted into programmed signals (data for selecting dispensing heads and tool paths) in a proper format, such as the standard NC G-codes commonly used in computerized numerical control (CNC) machinery industry. These layering data signals may be directed to a machine controller which selectively actuates the motors for moving the dispensing head with respect to the target surface, activates signal generators, drives the material supply means (if existing) for the dispensing head, drives the optional vacuum pump means, and operates optional temperature controllers, etc. It should be noted that although .STL file format has been emphasized in this paragraph, many other file formats have been employed in different commercial rapid prototyping and manufacturing systems. As indicated earlier, the VRML contains adequate information on the geometry and material distribution of a 3-D object. These file formats may be used in the presently invented system and each of the constituent segments or data points for the object geometry may be assigned a material composition code if an object of different material compositions at different portions is desired.

The three-dimensional motion controller is electronically linked to the mechanical drive means and is operative to actuate the mechanical drive means (e.g., those comprising stepper motors) in response to “X”, “Y”, “Z” axis drive signals for each layer received from the CAD computer. Controllers that are capable of driving linear motion devices are commonplace. Examples include those commonly used in a milling machine. Hence, this method may further comprise the steps of (1) creating a geometry of the object on a computer with the geometry including a plurality of segments or data points defining the object and materials to be used; and (2) generating program signals corresponding to each of these segments in a predetermined sequence, wherein the program signals determine the movement of the dispensing head and the target surface relative to one another in predetermined patterns.

At the conclusion of 3-D shape formation process, it is possible that some of the solvent still remains in the object. The present method may include additional steps of further removing a portion or a majority of the residual solvent ingredient after the object is constructed.

What is claimed:

1. A direct-write method for depositing a functional material with a preferred orientation onto a target surface, said method comprising the following steps:
(1) forming a precursor fluid to said functional material, said fluid containing a liquid component;
(2) operating dispensing means to discharge and deposit said precursor fluid onto said target surface in a substantially point-by-point manner and at least partially removing said liquid component from the deposited fluid to form a thin layer of said functional material which is substantially solidified and is of a predetermined pattern; and
(3) during said liquid-removing step, subjecting the deposited fluid to a highly localized electric or magnetic field for poling until a preferred orientation is attained in said functional material.

2. The direct-write method as defined in claim 1, wherein said predetermined pattern comprises at least a micron- and/or nanometer-scaled region of said functional material.

3. The direct-write method as defined in claim 1, wherein said highly localized electric or magnetic field is substantially focused in a region smaller than 10 μm in size.

4. The direct-write method as defined in claim 1, wherein said highly localized electric or magnetic field is generated by using a split-tip proximal probe.

5. The direct-write method as defined in claim 1, wherein said target surface is preheated or precooled to a desired temperature.

6. The direct-write method as defined in claim 1, wherein said target surface is exposed to a controlled atmosphere.

7. The direct-write method as defined in claim 6, wherein said controlled atmosphere is selected from a group consisting of a vacuum, an inert gas, a reactive gas, and a combination of an inert gas and a reactive gas.

8. The direct-write method as defined in claim 1, wherein said liquid-removing step involves operating a device selected from the group consisting of a ventilation fan, a vacuum pump, a hot air blower, a heater, or a combination thereof.

9. The direct-write method as defined in claim 1, 2, 3, 4, 5 or 6, wherein said functional material is selected from the group consisting of a piezo-electric material, a pyroelectric material, a ferro-electric material, a non-linear optic material, a conducting polymer, a ferromagnetic material, a ferri-magnetic material, an anti-ferromagnetic material, a liquid crystal material, a self-assembled material, or a combination thereof.

10. The direct-write method as defined in claim 1, 2, 3, 4, 5 or 6, wherein said functional material is a polarizable amorphous material.

11. The direct-write method of claim 10, wherein said amorphous material is a poly (vinylidene cyanide/vinyl acetate) copolymer.

12. The direct-write method as defined in claim 1, 2, 3, 4, 5 or 6, wherein said functional material is selected from the group consisting of poly (vinylidene fluoride), vinylidene fluoride copolymer, poly (vinylidene fluoride/trifluorethylene) copolymer, poly (vinylidene fluoride/tetrafluoroethylene) copolymer, or a mixture thereof.

13. The direct-write method as defined in claim 1, 2, 3, 4, 5 or 6, wherein said functional material comprises a polarized material that is a soluble ceramic material or a soluble polymer having polymer units capable of being polarized, selected from the group consisting of vinyl units, vinylidene units, ethylene units, acrylate units, methacrylate units, nylon units, carbonate units, acrylonitrile units, cellulose units, units having fluoro, chloro, amide, ester, cyanide, carbonate, nitrile or ether groups, protein units, or combinations thereof.

14. The direct-write method as defined in claim 1, 2, 3, 4, 5 or 6, wherein said dispensing means comprises a device selected from the group consisting of an inkjet printhead, a liquid droplet generator, an extrusion device, a gear pump, an air pressure pump, a positive displacement pump, a screw-driven pump, a syringe pump, a fused deposition modeling nozzle, or a combination thereof.

15. A freeform fabrication method for making a multiple-layer object comprising a functional material with a preferred orientation from a design created on a computer, comprising:
(1) providing a target surface on which said object is supported while being constructed;
(2) forming a precursor fluid to said functional material, said fluid containing a liquid component;
(3) operating dispensing means to discharge and deposit said precursor fluid onto selected regions of said target surface in a substantially point-by-point manner and at least partially removing said liquid component from the deposited fluid to form a first layer of substantially solidified functional material, said functional material in said selected regions forming a first predetermined pattern, leaving behind a remaining region free of said functional material on said first layer;
(4) during said liquid-removing step, subjecting the deposited fluid to a highly localized electric or magnetic field for poling until a preferred orientation is attained in said functional material;
(5) operating dispensing means to deposit at least a second material onto said remaining region of said first layer;
(6) repeating steps (3)-(5) for building multiple layers of said object, one layer upon another; and
(7) operating control means for generating control signals in response to coordinates of said design of said object and for controlling the movement of said dispensing means relative to said target surface in response to said control signals to control dispensing of said fluid and said at least a second material to construct said object.

16. The freeform fabrication method as defined in claim 15, wherein said control means include servo means for indexing and positioning said dispensing means relative to said target surface.

17. The method of claim 16, wherein said servo means provide indexing and positioning in at least two dimensions.

18. The method of claim 17, wherein said servo means provide indexing and positioning in a third dimension.

19. The method of claim 15, wherein said dispensing means comprises a plurality of inkjet print heads.

20. The method of claim 15, wherein said dispensing means comprises a plurality of nozzle orifices.

21. The method of claim 15 wherein said movement step comprises moving said dispensing means and said target surface relative to one another in a plane defined by first and second directions and in a third direction orthogonal to said plane to form said functional material and said at least a second material into a multi-layer object.

22. The method of claim 21, wherein said movement step includes the steps of:
moving said dispensing means and said target surface relative to one another in a direction parallel to said plane to form a first layer of said functional material and said at least a second material on said target surface with a portion of said liquid component being removed immediately after said precursor fluid is dispensed;
moving said dispensing means and said target surface away from one another in said third direction by a predetermined layer thickness distance; and
dispensing a second layer of said precursor fluid and said at least a second material onto said first layer and removing a portion of said liquid component from said fluid while simultaneously moving said dispensing means and said target surface in said direction parallel to said plane, whereby said second layer adheres to said first layer.

23. The method of claim 22, further including the steps of forming multiple layers of said functional material and said at least a second material on top of one another by repeated dispensing of said precursor fluid and said at least a second material and at least partially removing said liquid component in said dispensed fluid as said dispensing means and said target surface are moved relative to one another in one direction parallel to said plane, with said dispensing means and said target surface being moved away from one another in said third direction by a predetermined layer thickness after each preceding layer has been formed.

24. The method of claim 23, further including the steps of:
creating a geometry representation of said multiple-layer object on a computer, said geometry representation including a plurality of segments or data points defining said object;
generating programmed signals corresponding to each of said segments or data points in a predetermined sequence; and
moving said dispensing means and said target surface relative to one another in response to said programmed signals.

25. The method of claim 15, wherein said at least a second material comprises a material composition selected from the group consisting of a conductor, resistor, semi-conductor, capacitor, inductor, superconductor, diode, transistor, light-emitting element, light-sensing element, solar cell element, sensor, actuator, semiconductor logic element, electro-optic logic element, spin material, magnetic material, thermoelectric element, electromagnetic wave emission, transmission or reception element, electronically addressable ink, or a combination thereof.

26. The method as set forth in claim 25 wherein said functional material and said at least a second material are deposited at discrete locations in three-dimensional object space to form a spatially controlled material composition object.

27. A direct-write apparatus for depositing a functional material with a preferred orientation from a precursor fluid containing a liquid component, said apparatus comprising:
(1) a target surface on which said functional material is supported while being deposited;
(2) dispensing means at a distance from said target surface, said dispensing means having an orifice through which said precursor fluid is dispensed and deposited onto said target surface in a substantially point-by-point manner;
(3) liquid-removing means a distance from said orifice to at least partially remove said liquid component from the deposited precursor fluid;
(4) field source means a distance from said orifice for providing a highly localized electric or magnetic field for poling said deposited precursor fluid while said liquid component is being removed; and
(5) movement means in control relation to said dispensing means or said target surface for moving said dispensing means relative to said target surface.

28. The direct-write apparatus as defined in claim 27, wherein said dispensing means comprises a device selected from the group consisting of an inkjet printhead, a liquid droplet generator, an extrusion device, a gear pump, an air pressure pump, a positive displacement pump, a screw-driven pump, a syringe pump, a fused deposition modeling nozzle, or a combination thereof.

29. The direct-write apparatus as defined in claim 27, wherein said liquid-removing means comprises a device selected from the group consisting of a ventilation fan, a vacuum pump, a hot air blower, a heater, or a combination thereof.

30. The direct-write apparatus as defined in claim 27, wherein said field source means comprises a split-tip proximal probe.

31. The direct-write apparatus as defined in claim 27, wherein said movement means is electronically connected to a control means to regulate an operation of said movement means.

32. The direct-write method as defined in claim 1, 2, 3, 4, 5 or 6, further including a step of heat treating the deposited functional material.

33. The direct-write method as defined in claim 1, 2, 3, 4, 5 or 6, further including a step of generating a chemical reaction in said deposited precursor fluid.

34. The freeform fabrication method as defined in claim 15, further including a step of heat treating the deposited functional material.

35. The freeform fabrication method as defined in claim 15, further including a step of generating a chemical reaction in said deposited precursor fluid.

36. The direct-write method as defined in claim 1, 2, 3, 4, 5 or 6, wherein said localized electric or magnetic filed is generated by using a multiplicity of split-tip probes.

37. The freeform fabrication method as defined in claim 15, wherein said localized electric or magnetic filed is generated by using a multiplicity of split-tip probes.

38. The direct-write apparatus as defined in claim 27, wherein said field source means comprises a multiplicity of split-tip probes.
